(19) United States
(12) Patent Application Publication
(10) Pub. No.: US 2003/0177850 A1
(43) Pub. Date: Sep. 25, 2003

(54) System and method for verifying the roll roundness of rolls of paper used for newspapers

(75) Inventor: James Whittington, Fredericksburg, VA (US)

Correspondence Address: STERNE, KESSLER, GOLDSTEIN & FOX PLLC, 1100 NEW YORK AVENUE, N.W., WASHINGTON, DC, 20005, US

(73) Assignee: The Washington Post Company

(21) Appl. No.: 10/316,160

(22) Filed: Dec. 11, 2002

Related U.S. Application Data
(60) Provisional application No. 60/365,200, filed on Mar. 19, 2002.

(51) Int. Cl. G01B 17/06; G01B 121/04

(52) U.S. Cl. 73/865.8; 73/159; 702/179

(57) ABSTRACT

The present invention is directed to a system and method for verifying roll roundness of a cylindrical object and more particularly for verifying the roundness of rolls of papers used for newspaper printing. According to the present invention, a roll rotator is configured with a plurality of ultrasonic sensors, which are activated when a roll of paper is lifted and rotated by the roll rotator. The roll of paper is rotated an entire revolution and a plurality of distance measurements are taken at each sensor. As the readings are taken, a filter algorithm may be applied to remove values that are too far out of range, such as values which are representative of a torn wrapper or other defects in the covering surface of the roll. Once the readings have been taken, an average of the readings is calculated and the roundness algorithm compares each reading with the average for each of the sensors. The difference between each reading and the average are summed and squared and the standard deviation is calculated from the square root of that value. If the standard deviation is greater than a predetermined value the roll fails the roundness test. The predetermined value is dependent on a number of factors, including hardware tolerances, and can be altered for different requirements. In the case of a failure, the roll of paper is set aside in a designated reject area for further analysis. Rolls that pass the roll roundness test are sent on for use in the newspaper printing press.

### CROSS-REFERENCE TO RELATED APPLICATIONS

This application claims the benefit of U.S. Provisional Application No. 60/365,200, filed Mar. 19, 2002, incorporated by reference herein in its entirety.

### BACKGROUND OF THE INVENTION

1. Field of the Invention

The present invention is directed to a system and method for verifying roll roundness of a cylindrical object and more particularly for verifying the roll roundness of rolls of papers used for newspaper printing.

2. Related Art

The printing of newspapers involves multiple printing presses that process rolls of papers at high speeds. It is critical that the rolls of paper are uniform.

Any significant deviation will eventually cause problems with the printing of the newspaper.

Rolls of paper used in the printing of newspapers are frequently moved and handled prior to being used on the printing press, both in transit to the printing press and in storage and preparation for use at the printing press. Such manipulation may result in deformation of the paper roll, so that the paper roll is no longer as round as when it was wound. Measuring the roundness of a roll of paper prior to use on a printing press can alert an operator to potential problems prior to such problems interfering with the printing of the newspaper.

### SUMMARY OF THE INVENTION

The present invention is directed to an improved system and method for verifying roll roundness of a cylindrical object and more particularly for verifying the roundness of rolls of papers used for newspaper printing, which can easily be integrated into an automated paper handling system at a printing press. According to the present invention, a roll rotator is configured with a plurality of sensors, preferably ultrasonic sensors evenly distributed along the longitudinal axis of said roll rotator, which are activated when a roll of paper is lifted and rotated by the roll rotator. The roll of paper is rotated at least an entire revolution and a plurality of distance measurements are taken at each sensor.

As the readings are taken, a filter algorithm may be applied to remove values that are too far out of range and likely representative of a torn wrapper or other defects in the covering surface of the roll. In one embodiment, the filter algorithm continually adds the measured values together and divides that value by the number of readings that have been taken, to calculate a rolling average. This rolling average is used to filter the input from the sensors, removing values that are too far out of range of the rolling average. The filter algorithm may be adjusted as a result of testing to any preferred range, such that readings that are a predetermined distance above or below the rolling average are replaced by the rolling average. This lowers the possibility of torn wrappers and other defects in the covering surface of the roll from causing errors in the roll roundness calculation.

Once the readings have been taken the roll roundness is verified. In one embodiment, a final rolling average is calculated and the roundness algorithm compares each sensor reading with the average for each of the four sensors. The differences between each reading and the average are summed and squared and the standard deviation is calculated from the square root of that value. If the standard deviation is greater than a predetermined value the roll fails the roundness test. The actual value is dependent on a number of factors, including hardware tolerances, and can be altered for different requirements. In a preferred embodiment, the value is set to reflect an out-of-roundness measurement of approximately ⅜″. Alternative roundness calculations may also be made from the sensor readings, as would be apparent to one of ordinary skill in the relevant art, to verify roll roundness.

In one embodiment, in the case of a failure, the roll is set aside in a designated reject area for further analysis. Rolls that pass the roll roundness test are sent on for use in the printing press.

### BRIEF DESCRIPTION OF THE DRAWINGS/FIGURES

FIG. 1 is a detailed system diagram of a paper handling system including a roll roundness system according to the present invention.

FIG. 2 is a detailed system diagram of a portion of the paper handling system shown in FIG. 1, focusing on the accumulation conveyor, transfer table and downender components.

FIG. 3 is another detailed system diagram of a portion of the paper handling system shown in FIG. 1, focusing on the accumulation conveyor, transfer table and downender components.

FIG. 4 is a detailed system diagram of a portion of the paper handling system shown in FIG. 1, focusing on the transfer table, downender, roll conveyor and roll rotator components.

FIG. 5 is a detailed system diagram of a portion of the paper handling system shown in FIG. 1, focusing on the downender, roll conveyor and roll rotator components.

FIG. 6 is a detailed system diagram of the roll roundness system according to the present invention.

FIG. 7 is a detailed system diagram of a portion of the paper handling system shown in FIG. 1, focusing on the downender, roll conveyor, roll rotator and gullwing conveyor components.

### DETAILED DESCRIPTION OF THE INVENTION

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

The invention relates generally to handling rolls of paper that are used for printing newspapers. More particularly, the invention relates to using physical sensors to verify the roll roundness of rolls of paper.

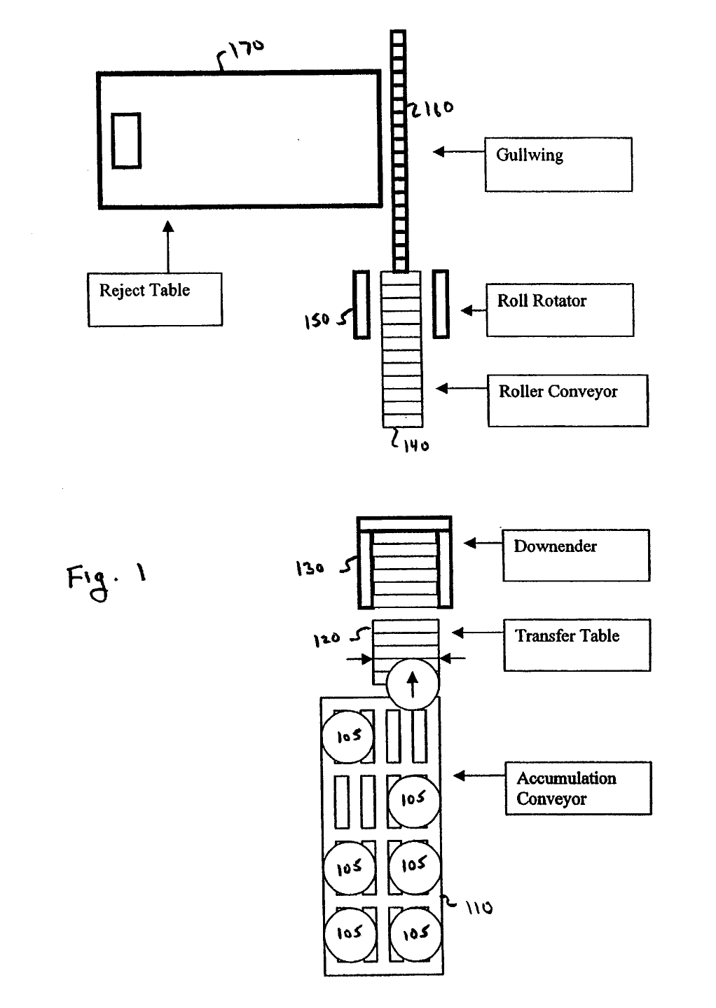

FIG. 1 shows a detailed diagram of one embodiment of a paper handling system including a roll roundness system according to the present invention. As would be apparent to one of ordinary skill in the art, alternative paper handling systems incorporating the roll roundness system of the present invention may also be used, without departing from the scope of the invention. In the embodiment shown, rolls of paper 105 are placed by a fork lift onto the end of an accumulation conveyor 110. Preferably, each roll of paper 105 has a barcode uniquely identifying the roll of paper for tracking purposes. The rolls of paper 105 are indexed as a set through the accumulation conveyor. Preferably, rolls of paper 105 are stacked one on top of the other on the accumulation conveyor 110, however, in an alternative embodiment, the rolls of paper are not stacked.

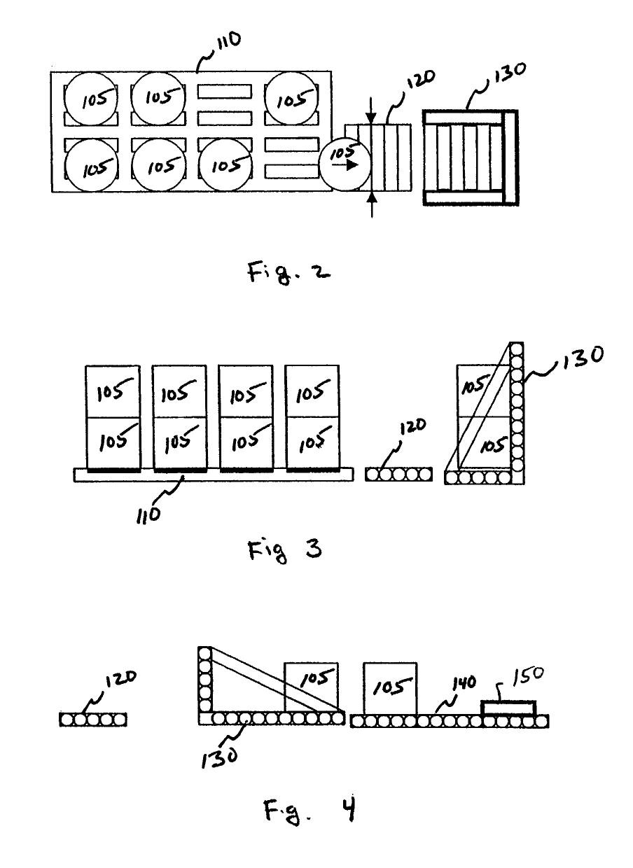

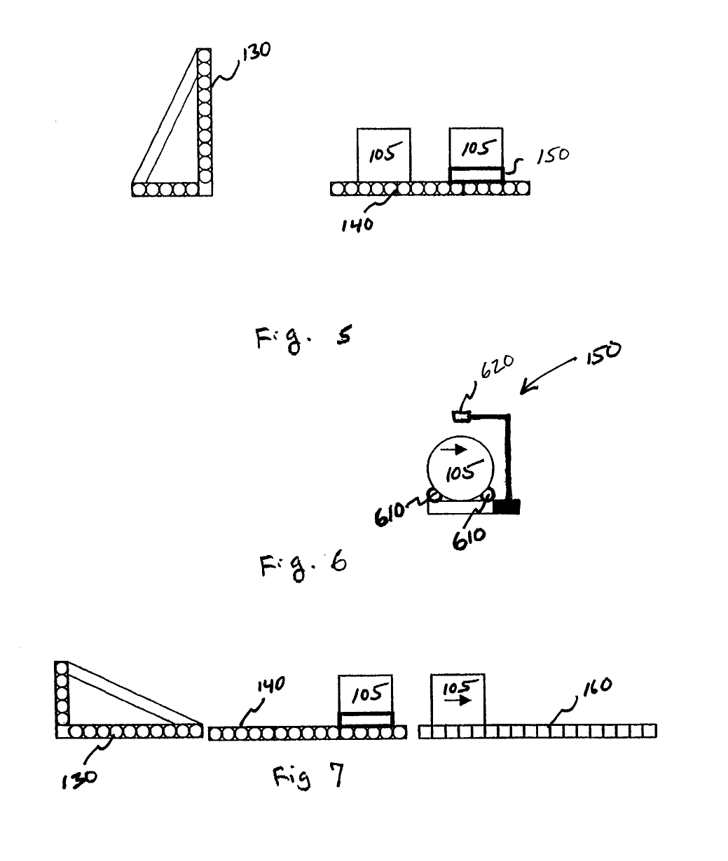

In the embodiment shown, the stacked rolls of paper 105 are centered and placed onto a transfer table 120 one stack at a time, as shown in FIG. 2. The rolls of paper 105 are then transferred to a downender 130, as shown in FIG. 3. The downender 130 lays the stacked rolls of paper 105 down onto their side, as shown in FIG. 4. One roll of paper 105 at a time moves along a roller conveyor 140 and onto a roll rotator 150, as shown in FIG. 5.

The roll rotator 150 consists of a set of motorized rollers 610, as shown in FIG. 6. The motorized rollers 610 lift and spin the roll of paper 105. In one embodiment, a barcode reader (not shown) detects the barcode on the roll of paper 105. The read barcode may be compared to an inventory database and if the roll is found in the inventory database, a signal is forwarded to a computer (not shown) indicating that the roll has been recorded as shipped. If the barcode is unreadable or is not in the database, a signal is forwarded to the computer indicating a bad roll has been detected. An operator can then manually read the barcode or reject the roll. A rejected roll of paper 105 may be transferred to a reject table 170.

The computer (not shown), which is connected to various components of the system, may include a graphical touch screen to allow the operator to control the operation described above. The computer is also configured with an analog input card for recording distance measurements from the sensors, as discussed below.

As shown in FIG. 6, in the roll roundness system of the present invention, the roll rotator 150 is configured with a plurality of sensors 620 for measuring roll roundness. In a preferred embodiment, four ultrasonic sensors 620 are disposed above roll rotator 150, however, any number of sensors may be used, as would be apparent to one of ordinary skill in the art. While ultrasonic sensors are preferred, alternative physical sensors may also be used, as would be apparent to one of ordinary skill in the art. Preferably, sensors 620 are evenly distributed along the longitudinal axis of roll rotator 150, such that readings may be taken from one end to the other end of a roll of paper 105 on roll rotator 150. The sensors are activated when the roll of paper 105 is lifted by the motorized rollers 610. The roll of paper 105 is rotated at least one entire revolution. The computer (not shown) connected to the system samples and saves distance readings from the sensors 620 via an analog input card while the roll of paper 105 is rotated. The sensors 620 output a value representative of the distance from the sensors 620 to the surface of the roll of paper 105 (e.g. a value between 5000 and 7000 units) when the roll of paper 105 is positioned and lifted under the senors 620. In one embodiment, a program executing on the computer takes 36 readings and saves each of the sensor readings in individual files; one file for each sensor. Of course, any number or readings can be taken as would be apparent to one of ordinary skill in the art.

In a preferred embodiment, a filter algorithm is used to remove sensor readings that are too far out of range. The filter of the present invention greatly increases the accuracy of the sensors by eliminating anomalies in the distance measurements. Torn wrappers on the roll of paper 105 or other defects in the surface of the roll are generally the cause of values that are too far out of range. As the readings are taken the program adds the values together and divides that value by the number of readings that have been taken to calculate a rolling average. This rolling average is used to filter the input from the sensors. The filter is set to exclude values that occur outside a predetermined range, e.g.±1000. The predetermined range may be adjusted as a result of testing. Of course, any value can be used to set the filter. In the example, if a reading is more than 1000 data points away from the rolling average, the reading is replaced by the rolling average. This lowers the possibility that torn wrappers and other defects in the covering surface of the roll of paper 105 will cause a false failure, as discussed below.

Once all of the readings have been taken, the roll roundness is verified. In one embodiment, a final running average is calculated. Then, the roll roundness program compares each reading with the final running average for each of the sensors. The differences between the readings and the final running average are added together and squared, and the square root of that value is calculated as the standard deviation. If the standard deviation is greater than a predetermined value the roll fails the roundness test. In a preferred embodiment, the value is chosen to correlate to a roll that is ⅜ of an inch out of round, which corresponds to a value between 125 and 147 in the example above. The actual value is dependent on a number of factors, including hardware tolerances. The value can obviously be altered for different requirements. It has been found that rolls of paper that are greater than ⅜ of an inch out of round have a high tendency to interfere with the proper working of a high speed newspaper printing press, however, higher or lower tolerances may be acceptable depending on printing equipment, press speed and other factors, as would be apparent to one of ordinary skill in the art. A sample calculation is shown in Table 1. In the sample calculation, 36 measurements were taken and the calculated standard deviation value was found to be within the acceptable tolerance limits.

In the case of a roll of paper 105 which fails the roundness test, an operator may use a graphical touch screen or other input device to retest the roll and/or manually reject or accept the roll of paper 105. Similarly, the user can disable the test if necessary via the graphical touch screen or other input device. In one embodiment, the graphical touch screen includes an indication that a failure has been detected. In other embodiment, the computer is configured with a LED or other indicator to indicate that a failure has been detected. The operator is allowed to manually reject a roll of paper 105 or accept a roll of paper regardless of the outcome of the calculations performed above. Alternatively, the paper handling system may automatically reject the failed roll of paper 105. In one embodiment, if the roll is rejected it is sent to the reject table 170. If the roll of paper 105 passes the roundness test, or is otherwise accepted, it is then transferred to the gullwing conveyor 160 for further processing and use on the printing press, as shown in FIG. 7.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above-described exemplary embodiments, but should be defined only in accordance with the following claims and their equivalents.

TABLE 1

| Reading # | Value | Average | Difference | Difference Squared |
|---|---|---|---|---|
| 1 | 5568 | 5538 | 30 | 900 |
| 2 | 5499 | 5538 | −39 | 1521 |
| 3 | 5535 | 5538 | −3 | 9 |
| 4 | 5512 | 5538 | −26 | 676 |
| 5 | 5578 | 5538 | 40 | 1600 |
| 6 | 5495 | 5538 | −43 | 1849 |
| 7 | 5489 | 5538 | −49 | 2401 |
| 8 | 5496 | 5538 | −42 | 1764 |
| 9 | 5506 | 5538 | −32 | 1024 |
| 10 | 5513 | 5538 | −25 | 625 |
| 11 | 5566 | 5538 | 28 | 784 |
| 12 | 5558 | 5538 | 20 | 400 |
| 13 | 5553 | 5538 | 15 | 225 |
| 14 | 5569 | 5538 | 31 | 961 |
| 15 | 5533 | 5538 | −5 | 25 |
| 16 | 5546 | 5538 | 8 | 64 |
| 17 | 5549 | 5538 | 11 | 121 |
| 18 | 5537 | 5538 | −1 | 1 |
| 19 | 5528 | 5538 | −10 | 100 |
| 20 | 5536 | 5538 | −2 | 4 |
| 21 | 5569 | 5538 | 31 | 961 |
| 22 | 5555 | 5538 | 17 | 289 |
| 23 | 5552 | 5538 | 14 | 196 |
| 24 | 5548 | 5538 | 10 | 100 |
| 25 | 5534 | 5538 | −4 | 16 |
| 26 | 5539 | 5538 | 1 | 1 |
| 27 | 5529 | 5538 | −9 | 81 |
| 28 | 5532 | 5538 | −6 | 36 |
| 29 | 5536 | 5538 | −2 | 4 |
| 30 | 5532 | 5538 | −6 | 36 |
| 31 | 5554 | 5538 | 16 | 256 |
| 32 | 5546 | 5538 | 8 | 64 |
| 33 | 5541 | 5538 | 3 | 9 |
| 34 | 5538 | 5538 | 0 | 0 |
| 35 | 5549 | 5538 | 11 | 121 |
| 36 | 5532 | 5538 | −6 | 36 |

Sum of Squared values 17260
Square root 131

What is claimed is:

1. A system for verifying the roundness of a roll of paper, comprising:
a roll rotator that rotates said roll of paper; and
a plurality of sensors connected to said roll rotator;
wherein a plurality of distance readings are taken from said plurality of sensors for verifying the roundness of said roll of paper.

2. The system of claim 1, wherein said system indicates whether said roll of paper is substantially round.

3. The system of claim 2, wherein said roll of paper is automatically discarded if said roll of paper is found to not be substantially round.

4. The system of claim 1, wherein each of said readings which are outside of a predetermined range are filtered from said roundness verification.

5. The system of claim 4, wherein a rolling average is calculated from said plurality of readings and said rolling average is used as a substitute reading for each reading which is outside of said predetermined range.

6. The system of claim 1, wherein said roundness verification is derived from a standard deviation of said plurality of readings.

7. The system according to claim 6, wherein said standard deviation is calculated by determining a plurality of first values by taking the difference between each sensor reading and said rolling average and squaring said difference, adding said plurality of first values to produce a second value, and determining the square root of said second value.

8. The system of claim 1, wherein said plurality of sensors are arranged along the longitudinal axis of said roll rotator.

9. The system of claim 8, wherein said plurality of sensors are evenly distributed along the longitudinal axis of said roll of paper from one end to the other end of said roll of paper.

10. The system of claim 1, wherein four sensors are arranged along the longitudinal axis of said roll of paper.

11. The system of claim 1, wherein said plurality of sensors are ultrasonic sensors.

12. The system of claim 1, further comprising an accumulation conveyor for moving said roll of paper toward said roll rotator.

13. The system of claim 1, further comprising a downender for laying said roll of paper on its side prior to said roll rotator rotating said roll of paper.

14. The system of claim 13, further comprising a roller conveyor that moves said roll of paper that has been placed on its side toward said roll rotator.
